(19) United States
(12) Patent Application Publication
(10) Pub. No.: US 2018/0280242 A1
(43) Pub. Date: Oct. 4, 2018

(54) ANAESTHETIC CARRIER

(71) Applicant: Uvamed Ltd., Loughborough (GB)

(72) Inventors: Keith Fawdington, Loughborough (GB); Shashi Gupta, Loughborough (GB)

(21) Appl. No.: 15/531,676

(22) PCT Filed: Dec. 1, 2015
(86) PCT No.: PCT/GB2015/053666

§ 371 Date: May 30, 2017

(30) Foreign Application Priority Data
Dec. 1, 2014 (GB) 1421285.6

(51) Int. Cl. A61J 7/00; B65D 1/36

(52) U.S. Cl. CPC A61J 7/0069; A61J 2205/20; B65D 1/36

(57) ABSTRACT

A pharmaceutical dosage form carrier comprising: a base tray having a base and side walls; and one or more transparent inserts; the base tray being configured to receive the one or more transparent inserts; each transparent insert having one or more upwardly opening receptacles extending from the base tray, the receptacles being elongate and arranged in a side-by-side array; each receptacle comprising: a respective base region; and one or more upwardly extending side portions; each receptacle being dimensioned to accommodate a container containing a predetermined dosage of a drug; wherein the base tray comprises one or more coloured panels arranged so that each coloured panel is visible through the base of the transparent inserts, the colour being selected to provide a visual indication of the dosage form to be accommodated in the receptacle.

This invention relates to a carrier for dosages of medicines, particularly but not exclusively to a carrier for syringes or ampoules containing dosages of drugs for use during surgical procedures, especially in operating theatres. The invention finds particular application for carrying several syringes or ampoules each containing one of a selection of drugs which may be required by an anaesthetist, registrar, nurse or other medical practitioner during a surgical procedure.

It is common in an operating theatre for syringes containing predetermined dosages of drugs to be prepared beforehand and provided in one or more trays arranged as required by the anaesthetist or other practitioner. A first tray may contain drugs for routine use and second and third trays may contain drugs for use in emergency situations. Mistakes are rare, but when they occur the consequences may be severe. Among the possible consequences, a patient may be paralysed but non-anaesthetised or a cardiac event may happen. Labelling of syringes is standardised, but syringes for different drugs, for example syntocinon and saline have the same coloured labels and may be of the same size. Furthermore, syringes for different drugs may be drawn by different practitioners.

Protocols involving checking by a second person are used, but following them may not always be possible in an emergency. Such checking increases time pressure on the practitioner and may result in possible distraction of the practitioner. A second person may not be immediately available during an emergency.

According to the present invention, a pharmaceutical dosage form carrier comprises a base and an array of upwardly opening receptacles extending from the base, the receptacles being elongate and arranged in a side-by-side array wherein each receptacle comprises; a respective base region and one or more upwardly extending side walls; each receptacle being dimensioned to accommodate a container for a predetermined dosage of a specific drug; wherein each base region comprises a coloured display panel, the colour being selected to provide a visual indication of the predetermined dosage form in the container to be accommodated in the receptacle.

The container may comprise a syringe or ampoule containing the dosage form of the specific drug. The container may also carry a label which may be colour coded.

The receptacles may be arranged in a parallel array so that the carrier may comprise a generally rectangular configuration. Preferably the carrier is arranged so that each container for a dosage form may lie above a respective display panel. This arrangement enables colouring of the label of the dosage form to be viewed simultaneously with the panel.

The carrier is preferably formed from a unitary moulding which is preferably composed of transparent polymeric material. Use of transparent material allows the coloured panel to be observed from either side. A transparent material particularly allows the coloured panel to be observed simultaneously with the dosage forms to enable a user to confirm that the dosage forms are correctly located.

The carrier may comprise a transparent polymeric tray configured to receive one or a plurality of transparent inserts, the or each insert including one or more of said receptacles, wherein the tray may further comprise an array of coloured panels wherein each panel is arranged to be visible through the base of a transparent insert, or the base of each insert may comprise a respective coloured panel.

In a preferred embodiment the tray and insert are both composed of transparent polymeric material, preferably from moulded sheet material.

The insert may comprise an array of upwardly opening receptacles separated by upwardly extending ribs, a lower surface of the insert comprising rebates corresponding to the interior surfaces of the ribs;

the tray comprising a tray base with two or more upwardly extending locating ribs, each locating rib being configured to be received in a respective rebate on the lower surface of the insert.

The rectangular tray may have front and rear up-standing walls and upstanding side walls extending between the front and rear walls, wherein the length of the side walls is less than the length of the front and rear walls;

two locating ribs extending upwardly between the front and rear walls, parallel to the side walls;

wherein the distance between a first locating rib and an adjacent side wall is different to the distance of a second locating rib and the other side wall.

The plan view of the tray and locating ribs may be asymmetric so that the location of these ribs is different if the tray is rotated through 180°. The configuration of the upstanding extending ribs and corresponding rebates of the insert is also asymmetric so that the insert may be only placed into the tray in engagement with the locating ribs with the locating ribs received in the rebates in a single orientation.

This prevents the insert from being placed in the tray incorrectly.

The carrier may comprise a peripheral flange, a cover being arranged to engage the flange to provide a sealed package. The cover may be formed from a transparent rigid polymeric material to allow visual inspection and checking of the contents of the carrier. The carrier and cover may have an interlocking clip-on arrangement.

Alternatively a peelable film may be applied to the tray to form a tamper proof cover.

The carrier of this invention has particular application for carrying syringes containing dosage forms which may be required in a surgical procedure, for example, anaesthesia, chemotherapy, veterinary or dental procedures in which a specific range of drugs is required to be immediately to hand.

The carrier may also find particular application in a mobile surgical facility such as a military field hospital or a drop-in medical centre to which pre-packaged sets of syringes or ampoules may be transported and stored before use.

Sterilised packaging in accordance with this invention may comprise the carrier with an array of syringes or ampoules and a cover sealed in a sterile bag.

The containers are preferably syringes, each syringe containing a predetermined dosage form, the dosage forms being arranged in a clearly identifiable way.

Preferably the containers are configured to allow stacking with other containers.

The receptacles are preferably dimensioned so that each may accommodate a specific size of syringe, the receptacle having one or more of a length, width and depth selected to permit a practitioner to easily pick up the syringe in use while making it visually evident if an inappropriately sized syringe is located within the receptacle. This reduces the chances of a syringe being misplaced.

Preferably the receptacles are configured to allow stacking with other corresponding receptacles.

Syringes for surgical use may have labels with a predetermined colour system. Use of trays with colour coded bases in accordance with the present invention has the advantage that a mismatch with the label may be more easily detected without the need to read the label.

Table 1 lists standard background colours for user applied syringe labels.

| Drug Class | Examples | Pantone ® colour (uncoated) |
|---|---|---|
| Induction agents | Thiopentone, etomidate, | Pantone ®Yellow (process) |
| | ketamine, propofol | |
| Hypnotics | Diazepam, lorazepam, | Pantone ®151 (orange) |
| | midazolam | |
| Hypnotic antagonists | Flumazenil | Pantone ® 151 (orange) with |
| | | white diagonal stripes |
| Muscle relaxants | Succinylcholine, pancuronium, | Pantone ® 805(fluorescent |
| | atracurium, mivacurium, | red or warm red) |
| | rocuronium | |
| Relaxant antagonists | Neostigmine, edophonium, | Pantone ® 805 (fluorescent |
| | pyridostigmine | red or warm red) with white |
| | | diagonal stripes |
| Narcotics | Morphine, fentanyl, | Pantone ® 297 (blue) |
| | remifentanil | |
| Narcotic antagonists | Naloxone | Pantone ® 297 (blue) with |
| | | white diagonal strips |
| Major tranquilizers | Droperidol, chlorpromazine | Pantone ® 156 (salmon) |
| Vasopressors | Epinephrine, ephedrine, | Pantone ® 256 (violet) |
| | phenylephrine | |
| Hypotensive agents | Nitroprusside, nitroglycerine, | Pantone ® (violet) with white |
| | phentolamine | diagonal strips |
| Local anaesthetics | Lignocaine, bupivacaine | Pantone ® 401 (grey) |
| Anticholinergic agents | Atropine, glycopyrrolate | Pantone ® 367 (green) |
| Other agents | Oxytocin, heparin, protamine, | Pantone ® transparent white |
| | antibiotics | |

In a preferred embodiment, the carrier may comprise a base tray and one or more of a plurality of inner trays, the base tray having one or more locations defined by formations configured to engage complementary formations of the or each respective inner tray of the array, the configuration of each location being arranged so that no other tray may be engaged at that location. Preferably a single insert is employed, the formations being configured so that the insert may be only engaged in the tray in a single orientation.

The base tray may have a double skin construction, comprising inner and outer polymeric sheets bonded at the upper periphery.

The base of this tray preferably comprises a peripheral downwardly extending projection flange or lip arranged to support the lower surface of the base above a work surface, the display being applied to the lower surface of the base. The lip preferably forms a continuous circumferential skirt extending around the base.

Provision of a projection flange or lip to raise the base of the tray above the work surface prevents abrasion or liquid damage to a coloured display provided on the lower surface of the tray. Multiple use of the base is facilitated.

A flange or lip may be provided around the upper edge of the carrier, inserts or both.

The display may be applied by printing or as a coloured adhesive film.

Alternatively a coloured printed sheet may be inserted between the skins to provide a waterproof display.

The display may additionally comprise labelling to provide a written indication of the correct intended dosage form of a syringe to be located in each receptacle.

The carrier may be formed by injection molding, thermoforming or by any other conventional means.

A carrier in accordance with this invention confers several advantages. A systematic approach to drawing up of drugs is facilitated allowing standardisation of storage of syringes, reducing any likelihood of confusion relating to location of the syringes in the carrier. Safe transfer of syringes between environments, for example the anaesthetic room and the theatre, is facilitated. Labelling may be visually compared to the coloured base so that misallocation of a syringe is more readily observed than when conventional fibreboard trays are employed.

The base may be colour coded in accordance with Royal College of Anaesthetists Guidelines. Enhanced visualisation of the printed black lettering on the syringe label is facilitated to emphasise when a syringe is placed in an incorrect section.

The invention is further described, by means of example but not in any limitative sense, with reference to the accompanying drawings, of which:

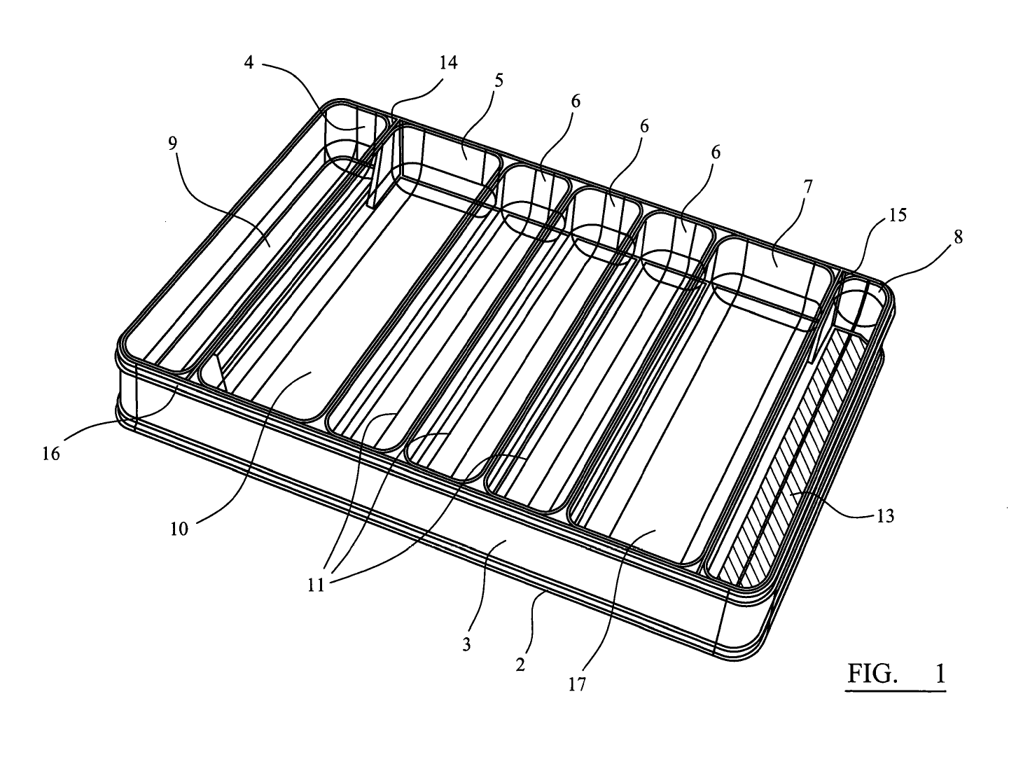

FIG. 1 is a perspective view of a carrier in accordance with this invention;

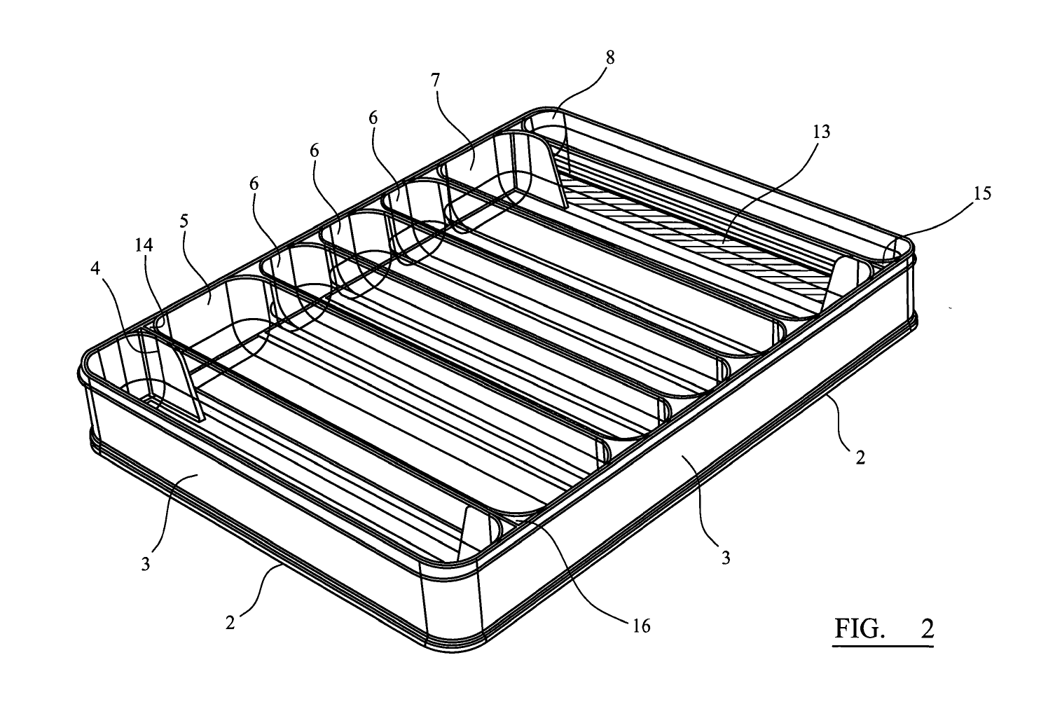

FIG. 2 is a further perspective view of the carrier shown in FIG. 1;

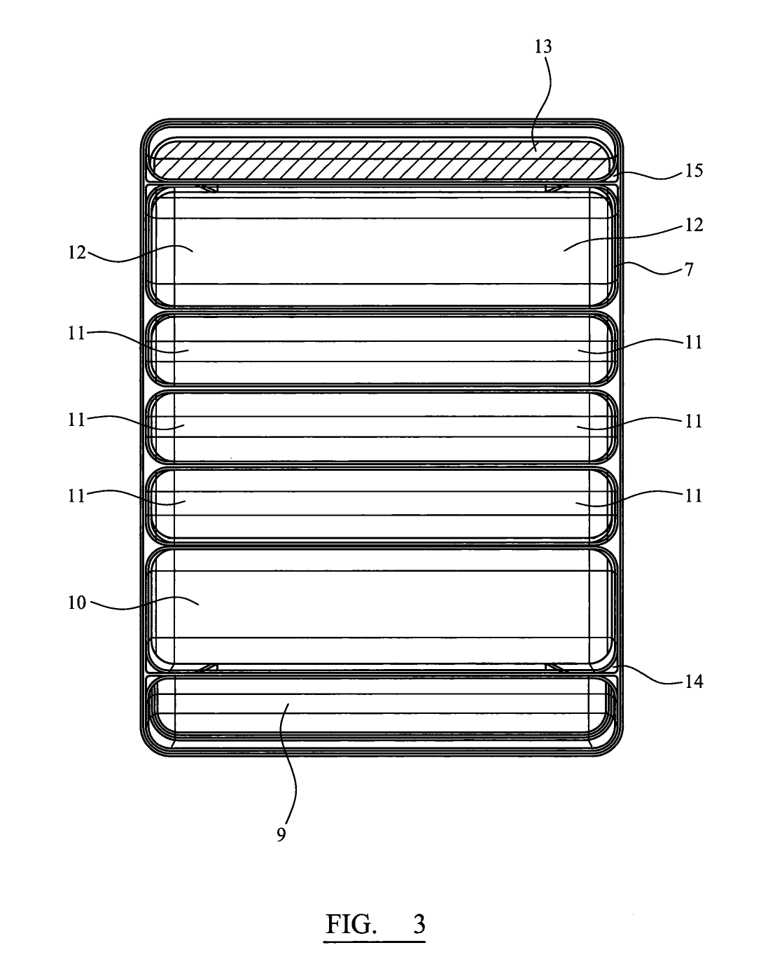

FIG. 3 is a plan view of the carrier;

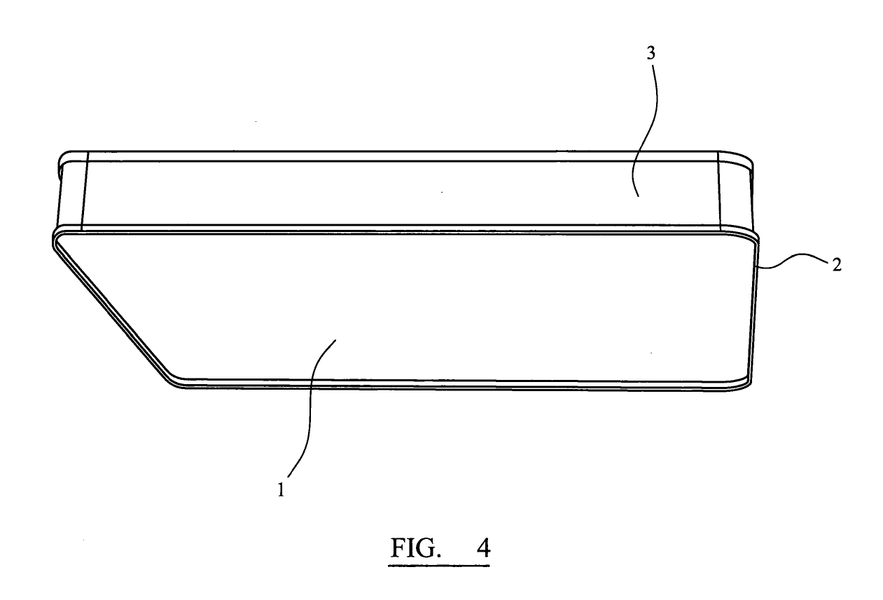

FIG. 4 is a view of the carrier from below;

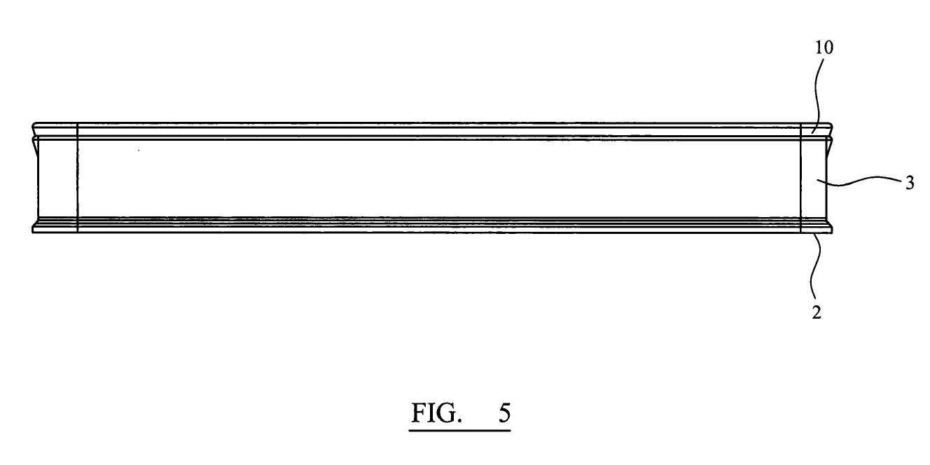

FIG. 5 is a side elevation view of the carrier;

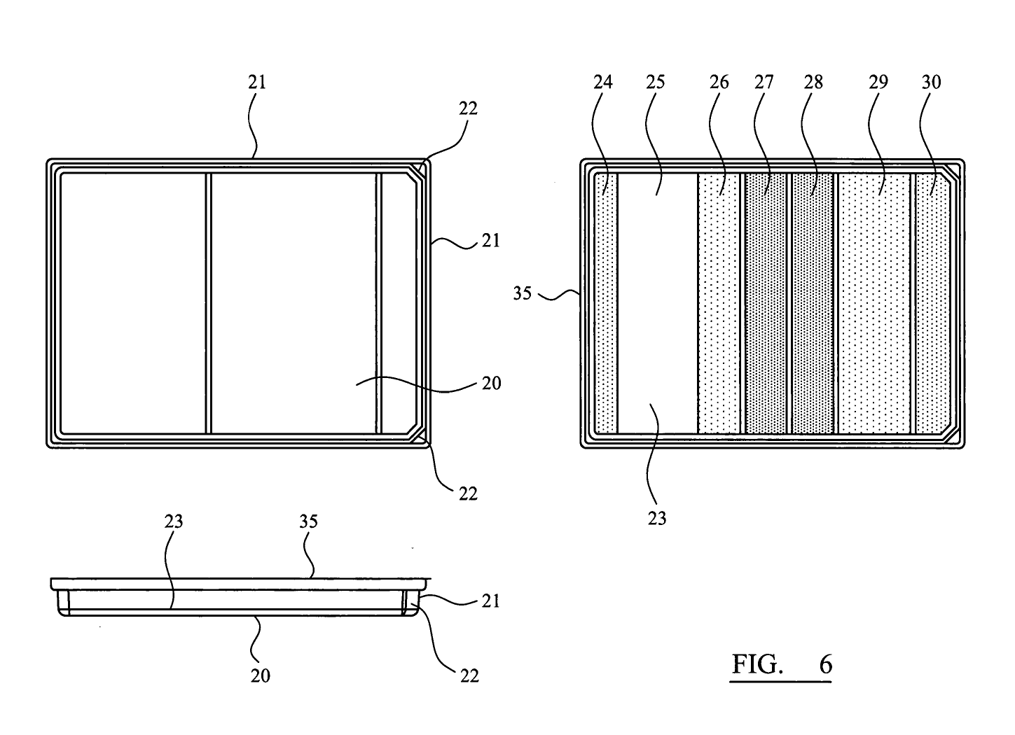

FIG. 6 shows a side elevation and views from above and below of a large tray base;

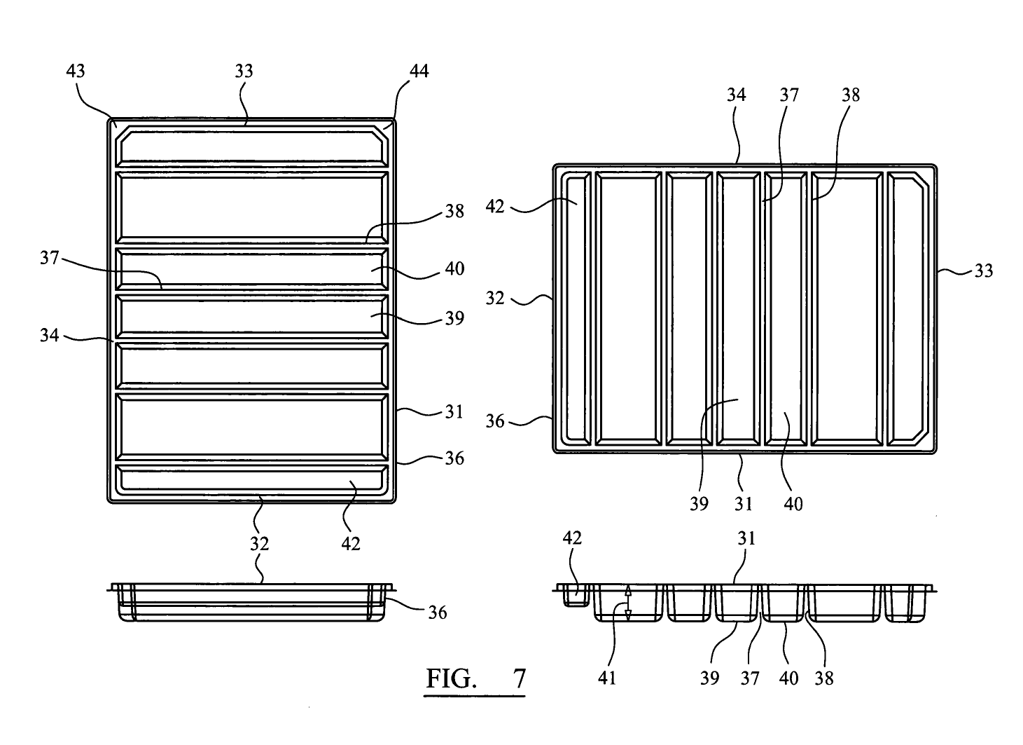

FIG. 7 shows an insert for the base shown in FIG. 6;

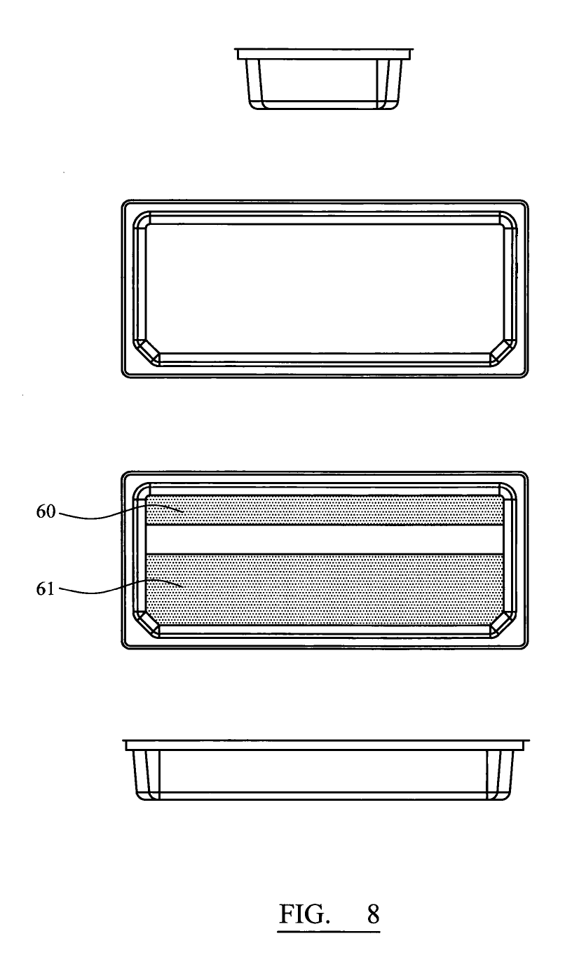

FIG. 8 shows a medium sized tray base;

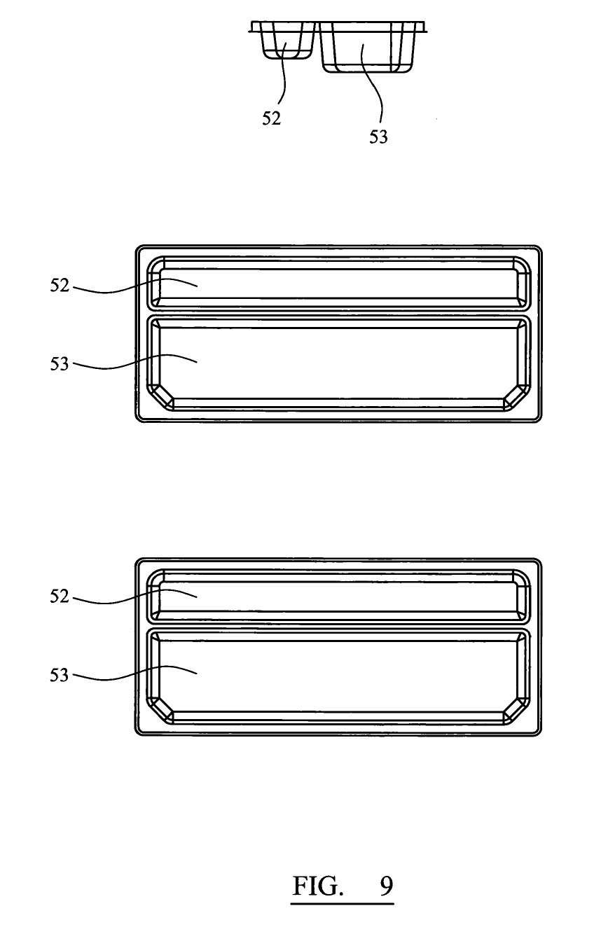

FIG. 9 shows the insert for the base shown in FIG. 8;

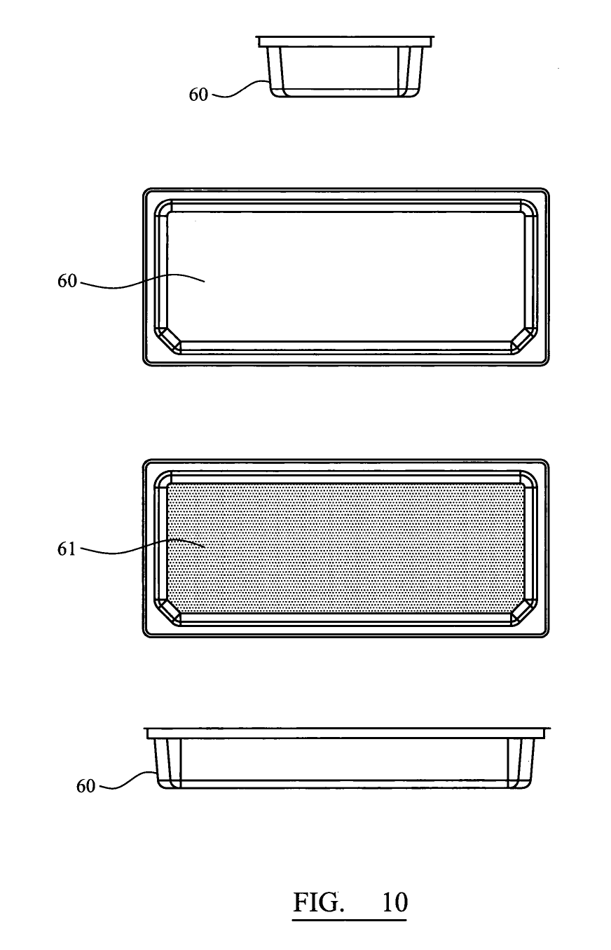

FIG. 10 shows a small tray base; and

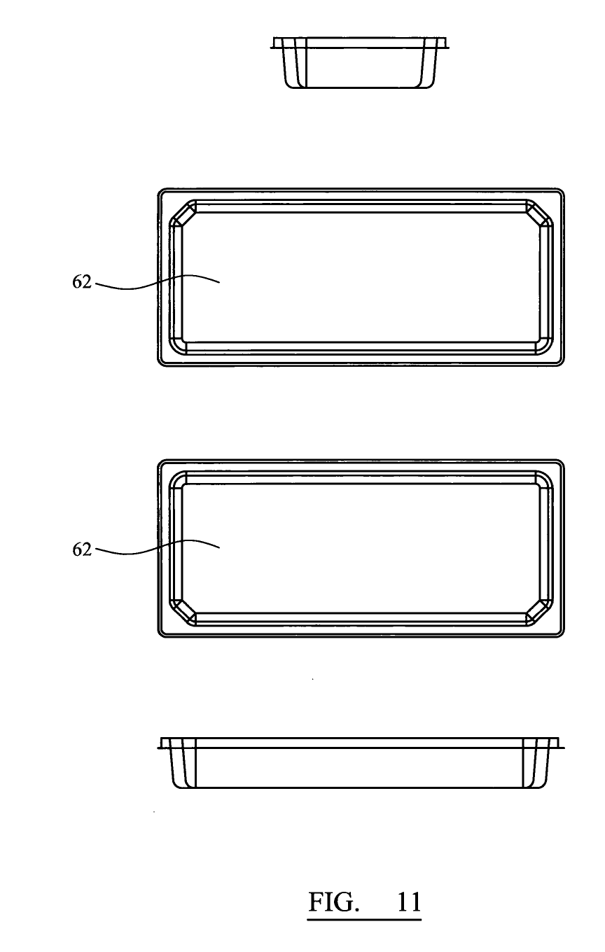

FIG. 11 shows an insert for the small tray base shown in FIG. 10.

The carrier shown in the Figures shows a generally rectangular base (1) having a peripheral downwardly extending lip (2), upwardly extending top, bottom and side walls (3). The top, bottom and side walls and base define a generally rectangular cavity in which one or more of a plurality of insert trays are received. The cavity may be divided into sub-cavities by cross-members (14,15) extending between the top and bottom walls and which form locating ribs.

The insert trays are elongate and parallel-sided, having respective bases (9-13) and upwardly extending side walls (4-8). A first tray comprises a base (9) and side walls (4) with a width and depth selected to receive and accommodate a specifically dimensioned syringe without allowing excessive movement of the syringe during transportation.

A second tray has a base (10) and side walls (5) with a width and depth selected to accommodate two or more syringes containing a dosage of a preselected drug.

Third, fourth and fifth trays have a base (11) and side walls (6) with a width and depth to each accommodate a single syringe of a preselected drug.

A sixth tray has a base (12) and side walls (7) with a width and depth selected to accommodate a large diameter syringe containing a preselected drug or alternatively to accommodate two or more smaller syringes.

A seventh tray has a raised base (13) and side walls (8), the raised base (13) reduces the depth of the receptacle to allow a practitioner to easily pick up a syringe having a small diameter.

A peripheral engagement flange extends around the upper surface of the side walls (6) to engage a cover or lid (not shown). Preferably, the cover is formed of transparent polymeric material and is arranged to clip onto the flange.

The base (1) has an array of coloured display panels. Each panel has a length and width allowing it to be exclusively observed through the base of a single respective tray (9,10,11,12,13).

Each coloured display may have a single Pantone or a pattern of differently coloured stripes.

In a further embodiment (not shown) the wall at the proximal side of the tray may have an indent in order to receive and locate a syringe plunger.

The lower flange (2) preferably extends continuously around the entire lower periphery of the carrier integral with the base (1) to provide a skirt forming an entire lower surface of the carrier in order to facilitate cleaning and sterilisation and to prevent ingress of fluids beneath the carrier in use.

FIGS. 6 to 11 illustrate an alternative embodiment comprising a kit of large, medium and small carriers. Each carrier comprises a base with a tray insert configured to be received in only one orientation within the base.

FIG. 6 shows plan views from below and above and a side elevation of a large dimensioned tray. The tray comprises a rectangular base panel (20) and a continuous side wall (21) having four rectangular sides. Adjacent corners (22) have inwardly extending triangular portions arranged to prevent the insert from being inserted into the tray in an incorrect orientation as described below.

In the upwardly facing interior surface (23) of the base is marked with seven parallel rectangular coloured panels (24 to 30). Each panel has a different colour formed by application of a coloured film, by printing or otherwise.

In a preferred example the first panel (24) is coloured orange, Pantone® 151 and may have a length of 40 mm, width of 225 mm and depth of 35 mm to receive a 5 ml capacity syringe.

The second panel (25) may be coloured Pantone® yellow having a length 60 mm, width 225 mm and depth 35 mm to receive a 50 ml syringe. The third panel (26) may be coloured Pantone® 805 fluorescent/warm red having a length of 40 mm, width of 225 mm and depth of 35 mm to receive a 10 ml capacity syringe body. The fourth panel (27) may be coloured Pantone® 297 blue and may have a length of 40 mm, width of 225 mm and depth of 35 mm to receive a 50 ml syringe body. The fifth panel (28) may be coloured Pantone® 156 salmon and have a length of 40 mm, width 225 mm and depth of 35 mm to receive a 5 ml syringe body. The sixth panel (29) may be coloured Pantone® transparent white and may have a length of 50 mm, width 225 mm and depth 35 mm to receive a 20 ml syringe body. The seventh panel (30) may be coloured Pantone® 805fluorescent/warm red with white diagonal stripes and have a length of 30 mm, width 225 mm and depth of 20 mm to receive a 5 ml syringe body. The coloured panels may include labels with written details of the dosage forms contained in the respective syringes.

FIG. 7 shows a transparent tray insert. The insert comprises an upper peripheral flange having sides (31) and (34) and ends (32, 33). The flange is arranged to engage and overlie the upper edge (35) of the side wall (21) of the base shown in FIG. 6. The flange has a lip (36) which extends downwardly over the edge (35) of the base to prevent ingress of liquid or debris between the tray and insert during use.

An array of parallel generally rectangular receptacles formed by downwardly extending side walls e.g. (37, 38) and base portions e.g. (39,40) the depth (41) of each receptacle is the same for most receptacles so that the bases (39, 40) form a continuous support surface. However the first cavity (42) has a reduced depth to accommodate a smaller, for example 5 ml syringe.

The coloured panels (24 to 30) of the tray base are visible through the transparent insert.

Adjacent corners (43, 44) at one end of the insert have triangular indented portions arranged to co-operate with complementary shaped dented portions (22) so that the insert may only be inserted into the tray base in one orientation preventing misalignment of the syringes with the respective coloured panels.

FIG. 8 shows a base for a medium sized carrier, the general configuration is similar to that shown in FIG. 6 except that the insert, shown in FIG. 9 has two receptacles to receive two syringes.

The base has only rectangular coloured panels (50, 51) visible from above.

The insert shown in FIG. 9 has two receptacles (52, 53) dimensioned to overlie the panels (50, 51) so that the panels may be observed through the basis of the transparent insert during use. The receptacle (52) is shallower in depth than the receptacle (53) so that a smaller sized syringe may be received and conveniently removed for use by a medical practitioner.

In a preferred example the first panel (52) is coloured violet, Pantone® 256 and may have a length of length of 55 mm, width of 225 mm and a depth of 35 mm to receive a 50 ml syringe body. The second panel is coloured green, Pantone® 367 and may have a length of 35 mm, width of 225 mm and a depth of 20 mm to receive a 5 ml syringe body.

FIGS. 10 and 11 show a third smaller base (60) having a single coloured panel (61) visible through the base of the insert (62) shown in FIG. 11.

In a preferred example the panel (61) is coloured grey, Pantone® 401 and may have a length of length of 110 mm, width of 225 mm and a depth of 35 mm to receive a 50 ml syringe body

The carrier arrangement shown in FIGS. 6 to 11 may be provided individually or as a kit of two or three carriers as required by a practitioner.

1. A pharmaceutical dosage form carrier comprising:
a base tray having a base and side walls; and
one or more transparent inserts;
the base tray being configured to receive the one or more transparent inserts;
each transparent insert having one or more upwardly opening receptacles extending from the base tray, the receptacles being elongate and arranged in a side-by-side array;
each receptacle comprising:
a respective base region; and
one or more upwardly extending side portions;
each receptacle being dimensioned to accommodate a container containing a predetermined dosage of a drug;
wherein the base tray comprises one or more coloured panels arranged so that each coloured panel is visible through the base of the transparent inserts, the colour being selected to provide a visual indication of the dosage form to be accommodated in the receptacle.

2. The carrier as claimed in claim 1, wherein the base tray comprises an upper and lower tray; wherein the upper tray has a complementary shape to the lower tray to allow housing of the upper tray within the lower tray and wherein the upper and lower trays may be peripherally bonded together.

3. The carrier as claimed in claim 2, wherein the one or more coloured panels are sealed between the upper and lower tray.

4. The carrier as claimed in claim 1, wherein the one or more coloured panels are detachable from the base tray.

5. The carrier as claimed in claim 1, wherein the base tray has one or more locations defined by formations configured to engage complementary formations on the one or more transparent inserts, the formations being arranged so that the transparent inserts are receivable within the base tray in only one configuration.

6. The carrier as claimed in claim 5, wherein the complementary formations restrict lateral movement of the transparent inserts.

7. The carrier as claimed in claim 5, wherein at least one of the formations of the base tray is a circumferentially extending shelf.

8. The carrier as claimed in claim 1, wherein the receptacles are arranged in a parallel array.

9. The carrier as claimed in claim 1, wherein each container lies above the coloured panels in use.

10. The carrier as claimed in claim 1, wherein the dosage forms are syringes or ampoules.

11. The carrier as claimed in claim 1, comprising a unitary moulding of opaque polymeric material.

12. The carrier as claimed in claim 1, wherein the transparent inserts have a peripheral flange arranged to engage a sealing cover.

13. The carrier as claimed in claim 12, wherein the base tray has a peripheral flange to contact the perimeter of the peripheral flange of the transparent inserts.

14. The carrier as claimed in claim 1, wherein each receptacle is dimensioned to accommodate a specific size of syringe.

15. The carrier as claimed in claim 1, wherein the base comprises a peripheral downwardly extending projection flange arranged to support the lower surface of the base above a work surface, the display being applied to the lower surface of the base.

16. A dosage form kit comprising:
a carrier as claimed in claim 1;
an array of syringes; and
a cover sealed within a sterile package.
